(19) United States
(12) Patent Application Publication
(10) Pub. No.: US 2024/0213457 A1
(43) Pub. Date: Jun. 27, 2024

(54) NEGATIVE ACTIVE MATERIAL FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Jaewon KIM, Yongin-si (KR); Yongseok KIM, Yongin-si (KR); Jaehou NAH, Yongin-si (KR); Youngugk KIM, Yongin-si (KR); Heeyoung CHU, Yongin-si (KR); Dae-Hyeok LEE, Yongin-si (KR); Hyejin KIM, Yongin-si (KR); Sojeong YU, Yongin-si (KR)

(21) Appl. No.: 18/535,191

(22) Filed: Dec. 11, 2023

(30) Foreign Application Priority Data
Dec. 16, 2022 (KR) 10-2022-0177405
Dec. 8, 2023 (KR) 10-2023-0178036

(51) Int. Cl. H01M 4/36; H01M 4/133; H01M 4/134; H01M 4/38; H01M 4/587; H01M 10/052

(52) U.S. Cl. CPC H01M 4/366; H01M 4/133; H01M 4/134; H01M 4/386; H01M 4/587; H01M 10/052; H01M 2004/027

(57) ABSTRACT

Disclosed are a negative active material for a rechargeable lithium battery and a rechargeable lithium battery. The negative active material for a rechargeable lithium battery includes a silicon-carbon composite; and graphene on a surface of the silicon-carbon composite, wherein a specific surface area of the negative active material is about 1.6 m²/g to about 2 m²/g.

### CROSS-REFERENCE TO RELATED APPLICATIONS

The present application claims priority to and the benefit of Korean Patent Application Nos. 10-2022-0177405 and 10-2023-0178036, filed on Dec. 16, 2022, and Dec. 8, 2023, respectively, in the Korean Intellectual Property Office the entire disclosures of each of which are incorporated herein by reference.

### BACKGROUND

### 1. Field

Embodiments of this disclosure relate to a negative active material for a rechargeable lithium battery and rechargeable lithium battery including the same.

### 2. Description of the Related Art

A rechargeable lithium battery which has recently drawn attention as a power source for small portable electronic devices, uses an organic electrolyte solution and thereby, have twice or more as high a discharge voltage as a comparative battery using an alkali aqueous solution and accordingly, high energy density.

As for a positive active material of a rechargeable lithium battery, oxides including lithium and a transition metal having a structure capable of intercalating/deintercalating lithium ions, such as LiCoO₂, LiMn₂O₄, LiNi₁₋ₓCoₓO₂ (0<x<1), and/or the like has been mainly used.

As for negative active materials, various suitable carbon-based materials such as artificial graphite, natural graphite, and hard carbon capable of intercalating and deintercalating lithium ions have been used. The graphite negative active material has a low capacity of 360 mAh/g, and therefore, the investigation for silicon having a capacity of four times or more than that have been actively undertaken.

However, silicon has about 300% of volume expansion during lithiation and delithiation of lithium and thus, as repeated charging and discharging is carried out, cracking and crumbling of the active material occurs. This causes repeated generation of a new interface and a solid electrolyte interface (SEI) layer because a reaction between the newly formed interface and an electrolyte is continuously or substantially continuously occurring, thereby deteriorating the cycle-life characteristics of the rechargeable lithium battery.

### SUMMARY

One embodiment of the present disclosure provides a negative active material for a rechargeable lithium battery which is capable of improving expansion characteristics and cycle-life characteristics of the rechargeable lithium battery.

Another embodiment provides a rechargeable lithium battery including the negative active material.

According to some embodiments, a negative active material for a rechargeable lithium battery includes a silicon-carbon composite; and graphene on a surface of the silicon-carbon composite, wherein a specific surface area of the negative active material is about 1.6 m²/g to about 2 m²/g, is provided.

According to some embodiments, a rechargeable lithium battery including a negative electrode including the negative active material, a positive electrode including a positive active material, and a non-aqueous electrolyte, is provided.

Example embodiments of the present disclosure are included in the following detailed description.

A negative active material for a rechargeable lithium battery may exhibit excellent cycle-life characteristics, and low volume expansion during charging and discharging, for example, the rechargeable lithium battery may exhibit excellent volume expansion characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic diagram showing a rechargeable lithium battery according to one embodiment.

FIG. 2 is a graph showing specific surface areas of the negative active materials according to Comparative Examples 1 to 3 and Examples 1 and 3 before and after heat-treating.

### DETAILED DESCRIPTION

Hereinafter, embodiments of the present disclosure are described in more detail. However, these embodiments are merely examples, the present disclosure is not limited thereto, and the present disclosure is defined by the scope of the appended claims, and equivalents thereof.

A negative active material for a rechargeable lithium battery according to one embodiment includes a silicon-carbon composite and graphene on a surface of the silicon-carbon composite. In some embodiments, a specific surface area of the negative active material is about 1.6 m²/g to about 2 m²/g. The specific surface area of the negative active material may be about 1.6 m²/g to about 1.9 m²/g. The specific surface area may be a Brunauer-Emmett-Teller (BET) specific surface area.

If the specific surface area of the negative active material according to one or more embodiments is within the ranges herein, excellent cycle-life characteristics and a low expansion rate of the rechargeable lithium battery may be realized. If the specific surface area is out of the ranges disclosed herein, a high expansion rate and low cycle-life characteristics may be exhibited by the rechargeable lithium battery during charge and discharge.

The specific surface area of the negative active material according to one or more embodiments may be up to about 30% higher than that of the silicon-carbon composite, and for example, if the specific surface area of the silicon-carbon composite is considered to be about 100%, the specific surface area of the negative active material corresponds to a maximum of about 130%.

As such, the negative active material according to some embodiments may have a non-excessive increase in specific surface area, even though the silicon-carbon composite core is coated with graphene.

The specific surface area of the negative active material may be about 130% or less relative to the specific surface area of the silicon-carbon composite (e.g., of the silicon-carbon composite on its own), for example, more than about 100% to about 130%, about 110% to about 130%, or about 120% to about 130%. The ranges of the specific surface area of the negative active material based on the specific surface area of the silicon-carbon composite core as disclosed herein may indicate that the graphene on the surface of the silicon-carbon composite is provided as a thin layer, for example, at a thickness of about 1 nm to about 20 nm (e.g., the graphene may be a layer on the silicon-carbon composite and have a thickness of about 1 nm to about 20 nm that extends from the surface of the silicon-carbon composite). In some embodiments, the silicon-carbon composite and the graphene form separate layers that are distinct from one another.

The negative active material according to some embodiments includes graphene on the surface, which may effectively diffuse lithium ions, improve electrical conductivity of the negative active material, and effectively secure a lithium ion diffusion path in the negative active material.

The graphene disclosed herein refers to materials having a plate-like structure, for example, a plate where carbons are connected, and a plurality of plates (e.g., plates including polycyclic aromatic carbon atoms bonded in a hexagonal lattice) may be stacked to form graphite, which is crystalline carbon. Generally, the term “graphene,” as used herein, indicates a form in which 8 to 15 plates are stacked, and in some embodiments, may be a form in which 1 to 8 plates are stacked. In some embodiments, the number of the stacked plates in the graphene is small (e.g., less than 8), which may further enhance the electrical conductivity and lithium ion diffusion rate of the negative active material.

The graphene according to some embodiments may be an exfoliated graphene, and may be prepared by electrochemically exfoliating crystalline carbon. The exfoliation may be performed by adding a crystalline carbon first electrode and a metal second electrode to a persulfate electrolyte and applying an electric field thereto. The crystalline carbon may be natural graphite, artificial graphite, or combinations thereof, and the metal may be aluminum, iron, potassium, magnesium, sodium, nickel, platinum, or combinations thereof. The persulfate electrolyte may be sodium persulfate, potassium persulfate, ammonium persulfate, or combinations thereof. The mole concentration thereof may be about 0.1 M to about 5 M. The voltage of the electric field may be about 10 V to about 100 V.

The negative active material according to one or more embodiments may have an electrical conductivity of about 16 S/cm or more, or about 16 S/cm to about 40 S/cm. If the electrical conductivity of the negative active material falls within the ranges disclosed herein, superior charge and discharge characteristics and a low expansion rate may be exhibited by the negative active material.

If the negative active material according to one embodiment is used together with a crystalline carbon negative active material, the surface contact with the neighboring crystalline carbon negative active material may be improved and the isolation of the active material caused during the charge and the discharge of the rechargeable lithium battery may be suppressed or reduced, so that the charge and discharge characteristics and the cycle-life characteristics of the rechargeable lithium battery may be more improved.

The silicon-carbon composite may extremely generate (e.g., may aggressively generate) an SEI (Solid Electrolyte Interface) film which is formed by reacting the silicon-carbon composite together with an electrolyte during charge and discharge of the rechargeable lithium battery to deteriorate the cycle-life characteristics of the rechargeable lithium battery. However, the negative active material according to one embodiment includes graphene on the surface of the silicon-carbon composite, and thus, a reaction of the silicon-carbon composite together with the electrolyte during charging and discharging of the rechargeable lithium battery may be prevented or reduced, thereby improving the cycle-life characteristics of the rechargeable lithium battery. As a result, volume expansion of silicon of the negative active material may be effectively suppressed or reduced, and thus, the mechanical strength of the negative active material may be secured or improved.

In some embodiments, an amount of the graphene may be about 0.6 parts by weight to about 4 parts by weight based on 100 parts by weight of the negative active material, or about 1 part by weight to about 3 parts by weight. If the amount of graphene is within the ranges disclosed herein, the volume expansion of the negative active material may be further effectively suppressed or reduced and the cycle-life characteristics of the rechargeable lithium battery may be further improved.

In some embodiments, the silicon-carbon composite may have a porous structure. The silicon-carbon composite may include nano silicon and an amorphous carbon, and/or an agglomerated product in which nano silicon and an amorphous carbon may be agglomerated together. According to some embodiments, the silicon-carbon composite may include an agglomerated product which is a secondary particle in which primary particles of nano silicon, for example, silicon nanoparticles are agglomerated together and amorphous carbon is filled between the agglomerated product which may be provided by surrounding a surface of the primary particles or which may be provided by surrounding a surface of the agglomerate product, the secondary particle. The negative active material according to some embodiments may include a porous structure having voids between the agglomerated products, for example, pores. For example, primary particles of the silicon-carbon composite (e.g., nano silicon) may have amorphous carbon surrounding (e.g., partially or completely surrounding) the primary particles, and/or secondary particles including agglomerated primary particles of the silicon-carbon composite may have amorphous carbon surrounding (e.g., partially or completely surrounding) the secondary particles.

The amorphous carbon may be soft carbon, hard carbon, mesophase, pitch carbide, sintered cokes, or combinations thereof.

In the silicon-carbon composite, a mixing ratio of nano silicon and the amorphous carbon may be about 70:30 to about 40:60 by weight ratio, or about 65:35 to about 40:60 by weight ratio.

The negative active material according to some embodiments may be prepared by mixing the silicon-carbon composite together with graphene and heat-treating the resultant mixture.

The graphene may be prepared by exfoliating graphite via an electrochemical method.

A mixing ratio of the silicon-carbon composite and the graphene may be about 99.4:0.6 to about 96:4 by weight ratio, or about 99:1 to about 97:3 by weight ratio.

The mixing may be performed in a solvent, and the solvent may be ethanol, isopropyl alcohol, water, or combinations thereof. During the mixing, an acid may be added thereto to control a pH thereof to be about 1 to about 6. The acid may be hydrochloric acid, nitric acid, phosphoric acid, or combinations thereof.

According to embodiments of the mixing, the mixture of graphene and the silicon-carbon composite may be precipitated due to the electrostatic interaction and graphene may be coated on the surface of the silicon-carbon composite.

The heat-treatment may be performed at about 600° C. to about 1,000° C., or about 800° C. to about 950° C. If the temperature of the heat treatment is out of the ranges disclosed herein, the contact between graphene and the silicon-carbon composite may be not formed and/or the silicon crystallite may be extremely increased.

The heat-treatment may be performed under an inert atmosphere, and the inert atmosphere may be N₂, argon, helium, or combinations thereof. If the heat-treatment is performed under an inert atmosphere, the oxidization of silicon and/or the generation of SiC may be prevented or reduced in the heat-treatment.

According to the heat-treatment, graphene may be firmly and closely provided on the silicon-carbon composite and the increase in the specific surface area of the final negative active material may be suppressed or reduced, so that the effects of using the graphene may be well obtained.

If the heat-treatment is not performed, due to the use of graphene, the specific surface area of the negative active material may be surprisingly or unsuitably increased, which may result in an unsuitable or inappropriate increase in the reaction with the electrolyte during charging and discharging of the rechargeable lithium battery, and the low bonding strength between the silicon-carbon composite and graphene may not be able to suitably or sufficiently suppress or reduce the volume expansion of silicon.

According to some embodiments, a rechargeable lithium battery including the negative electrode, a positive electrode, and an electrolyte, is provided.

The negative electrode may include a current collector and a negative active material layer on the current collector and including the negative active material according to one embodiment.

The negative active material layer may further include a crystalline carbon negative active material. The crystalline carbon negative active material may have an unspecified shape, sheet, flake, spherical and/or fiber shaped natural graphite and/or artificial graphite.

If the negative active material layer includes the negative active material according to some embodiments as a first negative active material and a crystalline carbon negative active material as a second negative active material, graphene of the first negative active material helps a surface of the first negative active material contact the second negative active material, and thus, the first negative active material may well contact (e.g., may suitably contact) the second negative active material, thereby effectively suppressing or reducing the expansion of the negative electrode. A mixing ratio of the first negative active material:the second negative active material may be about 1:99 to about 40:60 by weight ratio. If the mixing ratio of the first negative active material and the second negative active material is within the ranges disclosed herein, the current density of the negative electrode may be further improved and the more thin film may be prepared (e.g., a thinner film may be prepared). The first negative active material including silicon may be further uniformly (e.g., substantially uniformly) present in the negative electrode, resulting in further suppression or reduction of the expansion of the negative electrode.

In the negative active material layer, the amount of the negative active material may be about 95 wt % to about 99 wt % based on the total 100 wt % of the negative active material layer.

The negative active material layer may include a binder, and may further include a conductive material (e.g., an electrically conductive material). In the negative active material layer, an amount of the binder may be about 1 wt % to about 5 wt % based on the total 100 wt % of the negative active material layer. If the conductive material is further included, an amount of the negative active material may be about 90 wt % to about 98 wt %, an amount of the binder may be about 1 wt % to about 5 wt %, and an amount of the conductive material may be about 1 wt % to about 5 wt %.

The binder improves binding properties of positive electrode active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamide imide, polyimide, or combinations thereof.

The aqueous binder may be a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polyepichlorohydrin, polyphosphazene, an ethylene propylene diene copolymer, polyvinyl pyridine, chlorosulfonated polyethylene, latex, a polyester resin, an acrylic resin, a phenolic resin, an epoxy resin, polyvinyl alcohol, or combinations thereof.

If the aqueous binder is used as a negative electrode binder, a cellulose-based compound may be further used to provide viscosity as a thickener. The cellulose-based compound includes one or more of carboxymethyl cellulose, hydroxypropylmethyl cellulose, methyl cellulose, and/or alkali metal salts thereof. The alkali metal may be Na, K, and/or Li. The cellulose-based compound may be included in an amount of about 0.1 parts by weight to about 3 parts by weight based on 100 parts by weight of the negative active material.

The conductive material is included to provide electrode conductivity (e.g., electrical conductivity), and any suitable electrically conductive material may be used as a conductive material unless it causes a chemical change (e.g., an undesirable chemical change in the rechargeable lithium battery). Examples of the conductive material may be a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

The positive electrode may include a current collector and a positive active material layer including a positive active material, and formed on the current collector.

The positive electrode active material may include lithiated intercalation compounds that reversibly intercalate and deintercalate lithium ions. In some embodiments, one or more composite oxides of a metal selected from cobalt, manganese, nickel, and a combination thereof, and lithium, may be used. For example, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤ 0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤0.8, 0≤b≤0.5, 0≤c1≤0.05); LiₐNi_{1-b-c}CO_{b}X_{c}D¹_{α} (0.90≤a≤1.8, 0≤b≤0.5, 0≤c≤0.5, 0≤α≤2); LiₐNi_{1-b-c}CO_{b}X_{c}O_{2-α}T_{α} (0.90≤a≤1.8, 0≤b≤0.5, 0≤c≤0.5, 0≤α≤2); LiₐNi_{1-b-c}CO_{b}X_{c}O_{2-α}T₂ (0.90≤a≤1.8, 0≤b≤0.5, 0≤c≤0.5, 0≤α≤2); LiₐNi_{1-b-c}Mn_{b}X_{c}D¹_{α} (0.90≤a≤1.8, 0≤b≤0.5, 0≤c≤0.5, 0≤α≤2); LiₐNi_{1-b-c}Mn_{b}X_{c}O_{2-α}T_{α} (0.90≤a≤1.8, 0≤b≤0.5, 0≤c≤0.5, 0≤α≤2); LiₐNi_{1-b-c}Mn_{b}X_{c}O_{2-α}T₂ (0.90≤a≤1.8, 0≤b≤0.5, 0≤c≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNIVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulas, A is selected from Ni, Co, Mn, or combinations thereof; X is selected from Al, Ni, Co, Mn, Cr, Fe, Mg, Sr, V, a rare earth element, or combinations thereof; D¹ is selected from O, F, S, P, or combinations thereof; E is selected from Co, Mn, or combinations thereof; T is selected from F, S, P, or combinations thereof; G is selected from Al, Cr, Mn, Fe, Mg, La, Ce, Sr, V, or combinations thereof; Q is selected from Ti, Mo, Mn, or combinations thereof; Z is selected from Cr, V, Fe, Sc, Y, or combinations thereof; J is selected from V, Cr, Mn, Co, Ni, Cu, or combinations thereof; L¹ is selected from Mn, Al, or combinations thereof.

The compounds may have a coating layer on the surface thereof, or may be mixed together with another compound having a coating layer. The coating layer may include at least one coating element compound selected from the group consisting of an oxide of a coating element, a hydroxide of the coating element, an oxyhydroxide of the coating element, an oxycarbonate of the coating element, and a hydroxyl carbonate of the coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be provided by utilizing a method having no (or substantially no) adverse influence on properties of a positive electrode active material by using these elements in the compound, and for example, the method may include any suitable coating method such as spray coating, dipping, and/or the like, but is not illustrated in more detail here because it should be readily apparent to those of ordinary skill in the art upon reviewing this disclosure.

In the positive electrode, an amount of the positive active material may be about 90 wt % to about 98 wt % based on the total weight of the positive active material layer.

In embodiments, the positive active material layer may further include a binder and a conductive material (e.g., an electrically conductive material). The binder and the conductive material may each be included in an amount of about 1 wt % to about 5 wt %, respectively based on the total amount of the positive active material layer.

The binder improves binding properties of positive active material particles with one another and with a current collector. Examples of the binder may be polyvinyl alcohol, carboxymethyl cellulose, hydroxypropyl cellulose, diacetylcellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but is not limited thereto.

The conductive material is included to provide electrode conductivity (e.g., electrical conductivity), and any suitable electrically conductive material may be used as a conductive material unless it causes a chemical change (e.g., an undesirable chemical change in the rechargeable lithium battery). Examples of the conductive material may include a carbon-based material such as natural graphite, artificial graphite, carbon black, acetylene black, ketjen black, a carbon fiber and the like; a metal-based material of a metal powder and/or a metal fiber including copper, nickel, aluminum, silver, and the like; a conductive polymer such as a polyphenylene derivative; or a mixture thereof.

The current collector may include aluminum foil, nickel foil, or a combination thereof, but is not limited thereto.

The positive active material layer and the negative active material layer may be prepared by mixing together the active material, the binder, and optionally, the conductive material in a solvent to prepare an active material composition and coating the active material composition on the current collector. Such an active material layer preparation method should be readily apparent to one of ordinary skill in the art upon reviewing this disclosure, and therefore, further detailed description thereof will not be repeated here. The solvent may be N-methyl pyrrolidone, but is not limited thereto. If the binder is a water-soluble binder in the negative active material layer, the solvent used for preparing the negative active material composition may be water.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester solvent may include methyl acetate, ethyl acetate, n-propyl acetate, dimethyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone, and/or the like. The alcohol-based solvent may include ethyl alcohol, isopropyl alcohol, and/or the like, and examples of the aprotic solvent include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and/or the like.

The organic solvent may be used alone or in a mixture. If the organic solvent is used in a mixture, the mixture ratio may be controlled in accordance with a suitable or desirable battery performance, and should be readily apparent to one of ordinary skill in the art upon reviewing this disclosure.

If the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may be methyl propionate, ethyl propionate, propyl propionate, or a combination thereof.

If the cyclic carbonate and the chain carbonate or the cyclic carbonate and the propionate-based solvent are mixed together, they may be mixed together in a volume ratio of about 1:1 to about 1:9 and thus performance of an electrolyte solution may be improved. In some embodiments, if the cyclic carbonate, the chain carbonate, and the propionate-based solvent are mixed together, they may be mixed together in a volume ratio of about 1:1:1 to about 3:3:4. The mixing ratios of the solvents may be suitably or appropriately adjusted according to suitable or desirable properties.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

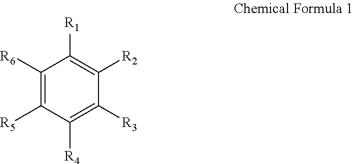

In Chemical Formula 1, R₁ to R₆ are the same or different and are selected from hydrogen, a halogen, a C1 to C10 alkyl group, a haloalkyl group, and a combination thereof.

Examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or combinations thereof.

The electrolyte may further include vinylethyl carbonate, vinylene carbonate, an ethylene carbonate-based compound represented by Chemical Formula 2 as an additive for improving cycle life.

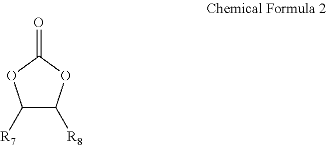

In Chemical Formula 2, R₇ and R₈ are the same or different and may each be independently hydrogen, a halogen, a cyano group (CN), a nitro group (NO₂), or a C1 to C5 fluoroalkyl group, provided that at least one selected from R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and/or the like. An amount of the additive for improving the cycle-life characteristics may be used within a suitable or appropriate range.

The electrolyte may further include propane sultone, succinonitrile, or combinations thereof, and the used amount thereof may be suitably controlled.

The lithium salt dissolved in an organic solvent supplies the rechargeable lithium battery with lithium ions, basically operates the rechargeable lithium battery, and improves transportation of the lithium ions between a positive electrode and a negative electrode. Examples of the lithium salt include at least one or two supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer of about 1 to about 20, lithium difluoro(bisoxolato) phosphate, LiCl, LiI, LiB(C₂O₄)₂ (lithium bis(oxalato) borate: LiBOB), or lithium difluoro(oxalate)borate (LiDFOB). A concentration of the lithium salt may range from about 0.1 M to about 2.0 M. If the lithium salt is included at the above concentration range, an electrolyte may have excellent performance and lithium ion mobility due to suitable or optimal electrolyte conductivity and viscosity.

A separator may be between the positive electrode and the negative electrode depending on a type (or kind) of a rechargeable lithium battery. The separator may use polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

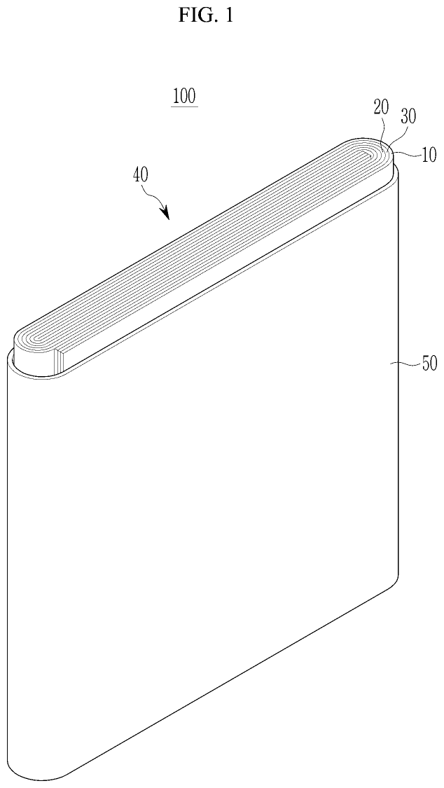

FIG. 1 is an exploded perspective view of a rechargeable lithium battery according to an embodiment. The rechargeable lithium battery according to some embodiments is illustrated as a prismatic battery but is not limited thereto and may include variously-shaped batteries such as a cylindrical battery, a pouch battery, and/or the like.

Referring to FIG. 1, a rechargeable lithium battery 100 according to an embodiment may include an electrode assembly 40 manufactured by winding a separator 30 between a positive electrode 10 and a negative electrode 20 and a case 50 housing the electrode assembly 40.

An electrolyte may be impregnated in the positive electrode 10, the negative electrode 20 and the separator 30.

Hereinafter, examples of the present disclosure and comparative examples are described. These examples, however, are not in any sense to be interpreted as limiting the scope of the present disclosure.

### Example 1

99 wt % of a silicon-carbon composite and 1 wt % of graphene were mixed together. The mixture was heat-treated at 950° C. under an N₂ atmosphere to prepare a negative active material.

The graphene was used, which was produced by adding an artificial graphite first electrode and a platinum second electrode to a sodium persulfate electrolyte and applying a voltage of 10 V across the first electrode and the second electrode.

As the silicon-carbon composite, a soft carbon coating layer on an agglomerated product in which silicon nanoparticles having an average particle diameter D50 of 100 nm and soft carbon were agglomerated, was used. Based on the total weight of the silicon-carbon composite, an amount of the silicon nanoparticles was 54 wt % and an amount of the soft carbon was 46 wt %.

The negative active material was used as a first negative active material and natural graphite was used as a second negative active material. The first negative active material and the second negative active material were mixed together at a weight ratio of 13.5:86.5 to prepare a composite negative active material. The composite negative active material, a styrene-butadiene rubber binder and carboxymethyl cellulose thickener were mixed together at a weight ratio of 97.5:1.5:1 in a water solvent to prepare a negative active material layer slurry.

The negative active material slurry was coated on a Cu foil current collector, dried, and pressurized utilizing a technique generally used in the art to prepare a negative electrode including the current collector and a negative active material layer on the current collector. The prepared negative active material layer had a loading level of 6.8 mg/cm² and an active mass (referred to as a negative active material layer) density of 1.6 g/cm³.

Using the negative electrode, a LiCoO₂ positive electrode, and an electrolyte, a rechargeable lithium full cell was fabricated. As the electrolyte, 1.5 M LiPF₆ dissolved in a mixed solvent of ethylene carbonate, ethylmethyl carbonate, and dimethyl carbonate (20:10:70 volume ratio) was used.

### Example 2

A negative active material was prepared by substantially the same procedure as in Example 1, except that 98 wt % of the silicon-carbon composite and 2 wt % of graphene were mixed together. Using the negative active material as a first negative active material, a negative electrode and a rechargeable lithium full cell were fabricated by substantially the same procedure as in Example 1.

### Example 3

A negative active material was prepared by substantially the same procedure as in Example 1, except that 97 wt % of the silicon-carbon composite and 3 wt % of graphene were mixed together. Using the negative active material as a first negative active material, a negative electrode and a rechargeable lithium full cell were fabricated by substantially the same procedure as in Example 1.

### Comparative Example 1

The silicon-carbon composite used in Example 1 was used as a negative active material to prepare a negative electrode. Using the negative active material, a negative electrode and a rechargeable lithium full cell were fabricated by substantially the same procedure as in Example 1.

### Comparative Example 2

A negative active material was prepared by substantially the same procedure as in Example 1, except that 99.9 wt % of the silicon-carbon composite and 0.1 wt % of graphene were mixed together. Using the negative active material as a first negative active material, a negative electrode and a rechargeable lithium full cell were fabricated by substantially the same procedure as in Example 1.

### Comparative Example 3

A negative active material was prepared by substantially the same procedure as in Example 1, except that 95 wt % of the silicon-carbon composite and 5 wt % of graphene were mixed together. Using the negative active material as a first negative active material, a negative electrode and a rechargeable lithium full cell were fabricated by substantially the same procedure as in Example 1.

### Comparative Example 4

A negative active material was prepared by substantially the same procedure as in Example 1, except that 99 wt % of the silicon-carbon composite and 1 wt % of graphene were mixed together and the heat-treatment was not performed. Using the negative active material as a first negative active material, a negative electrode and a rechargeable lithium full cell were fabricated by substantially the same procedure as in Example 1.

### Comparative Example 5

A negative active material was prepared by substantially the same procedure as in Example 1, except that 98 wt % of the silicon-carbon composite and 2 wt % of graphene were mixed together and the heat-treatment was not performed. Using the negative active material as a first negative active material, a negative electrode and a rechargeable lithium full were fabricated by substantially the same procedure as in Example 1.

### Comparative Example 6

A negative active material was prepared by substantially the same procedure as in Example 1, except that 97 wt % of the silicon-carbon composite and 3 wt % of graphene were mixed together and the heat-treatment was not performed. Using the negative active material as a first negative active material, a negative electrode and a rechargeable lithium full cell were fabricated by substantially the same procedure as in Example 1.

### Comparative Example 7

A negative active material was prepared by substantially the same procedure as in Example 1, except that 1 wt % of graphene oxide was used, instead of 1 wt % of graphene. Using the negative active material as a first negative active material, a negative electrode and a rechargeable lithium full cell were fabricated by substantially the same procedure as in Example 1.

The graphene oxide used was commercially available graphene oxide prepared by a Hummers' method (manufacturer: Sigma-Aldrich).

### Experimental Example 1) Evaluation of Electrical Conductivity

The electrical conductivities of the negative active materials according to Examples 1 to 3 and Comparative Examples 1 to 7 were measured by a powder resistance measurement (4 points probes method). The results are shown below in Table 1.

### Experimental Example 2) Evaluation of Specific Surface Area

The BET specific surface areas of the negative active materials according to Examples 1 to 3 and Comparative Examples 1 to 7 were measured by using a Micromeritics (ASAP 2020) equipment in which desorption and adsorption of nitrogen gas was used. The results are shown below in Table 1.

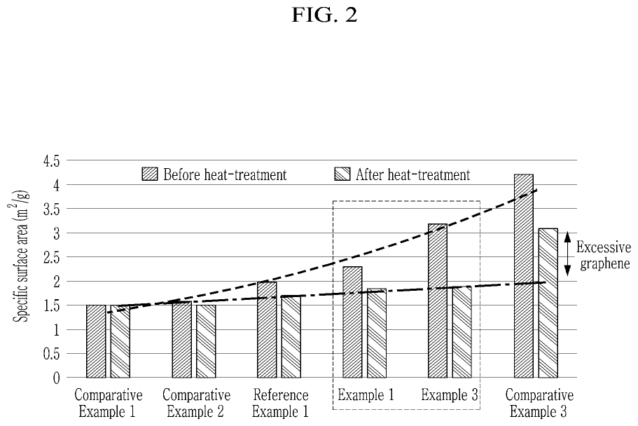

For identifying the increases in the specific surface are due to the heat treatment, the specific surface areas of the negative active materials according to Comparative Examples 1 to 3 and Examples 1 and 3 before and after heat-treating were measured by using a Micromeritics (ASAP 2020) equipment. The results are shown in FIG. 2.

### Experimental Example 3) Measurements of Initial Expansion Rate and 20^{th} Cycle Expansion Rate

The cells according to Examples 1 to 3 and Comparative Examples 1 to 7 were formation charged and discharged at 0.1 C once and then charged and discharged at 1 C for 20 cycles. A ratio of the cell thickness after charging and discharging once relative to the cell thickness before the formation (0.1 C) charging and discharging was calculated. The results are shown below in Table 1, as the initial expansion rate. A ratio of the cell thickness after charging and discharging at 1 C for 20 cycles relative to the cell thickness before charging and discharging was calculated. The results are shown below in Table 1, as cycle-life expansion rate at 20^{th} cycle.

### Experimental Example 4) Evaluation of Capacity Retention

The cells of Examples 1 to 3 and Comparative Examples 1 to 7 were charged and discharged at 1 C for 20 cycles. A ratio of the discharge capacity at 20^{th} cycle to the discharge capacity at 1^{st} cycle was measured. The results are shown below in Table 1, as cycle-life retention.

TABLE 1

| | | Specific surface | Specific surface | | Initial | Expansion | Cycle-life |
|---|---|---|---|---|---|---|---|
| | Electrical | area of silicon- | area of negative | | expansion | rate at | retention at |
| | conductivity | carbon composite | active material | (B/A)*100 | rate | 20^{th} cycle | 20^{th} cycle |
| | (S/cm) | (A, m²/g) | (B, m²/g) | (%) | (%) | (%) | (%) |
| Example 1 | 19 | 1.52 | 1.85 | 121.7 | 19.7 | 10.7 | 95.8 |
| Example 2 | 26 | 1.52 | 1.87 | 123 | 19.4 | 10.8 | 96.0 |
| Example 3 | 28 | 1.52 | 1.88 | 123.7 | 19.6 | 11.2 | 96.3 |
| Comparative | 8 | 1.52 | 1.52 | 100 | 24.9 | 16.0 | 95.3 |
| Example 1 | | | | | | | |
| Comparative | 12 | 1.52 | 1.51 | 99.3 | 24.6 | 14.7 | 94.2 |
| Example 2 | | | | | | | |
| Comparative | 31 | 1.52 | 3.06 | 201.3 | 19.6 | 11.5 | 93.1 |
| Example 3 | | | | | | | |
| Comparative | 11 | 1.52 | 2.28 | 150 | 22.1 | 14.1 | 95.1 |
| Example 4 | | | | | | | |
| Comparative | 11 | 1.52 | 3.18 | 209.2 | 21.2 | 13.7 | 94.5 |
| Example 5 | | | | | | | |
| Comparative | 12 | 1.52 | 4.19 | 275.7 | 21.0 | 13.9 | 94.6 |
| Example 6 | | | | | | | |
| Comparative | 15 | 1.52 | 3.21 | 211.2 | 24.4 | 15.5 | 93.3 |
| Example 7 | | | | | | | |

As shown in Table 1, the negative active materials using graphite of 1 wt % to 3 wt % and that were subjected to the heat treatment, exhibited a specific surface area corresponding to 120% to 130% relative to the specific surface area of the silicon-carbon composite.

Whereas, the negative active materials according to Comparative Example 3 using graphene of 5 wt % which was an excessively large amount and Comparative Examples 4 to 6 which were not subjected to heat-treatment exhibited an excessively increased specific surface area of 150% to about 276% relative to the specific surface area of the silicon-carbon composite.

The increases in specific surface area due to the heat-treatment and excessive use of graphene may be clearly shown in FIG. 2. As shown in FIG. 2, if graphene is used at an amount of 1 wt % to 3 wt %, the addition of graphene increases the specific surface area, but the specific surface of the final negative active material does not substantially increase due to the heat-treatment. In Comparative Example 3 which includes graphene, but the amount thereof is excessive, the specific surface area was abruptly and excessively increased, although the heat-treatment was performed.

Examples 1 to 3 exhibited surprisingly low initial expansion and 20^{th} cycle expansion compared to Comparative Example 1 which did not include graphene, and thus, exhibited excellent expansion characteristics and excellent cycle-life characteristics.

Whereas, Comparative Examples 2 to 6, in which graphene was used in too small or excessive amounts, or the heat treatment was not performed, exhibited slightly lower expansion at initial and at 20^{th} cycle, compared to Comparative Example 1, but higher than Example 1, and exhibited deteriorated cycle-life characteristics.

In Comparative Example 7 using graphene oxide, the negative active material had a much higher specific surface area than that of the silicon-carbon composite, exhibited significantly enlarged expansion at initial and at 20^{th} cycle, and showed deteriorated cycle-life characteristics.

While the subject matter of this disclosure has been described in connection with what are presently considered to be practical example embodiments, it is to be understood that the present disclosure is not limited to the disclosed embodiments, but, on the contrary, is intended to cover various modifications and equivalent arrangements included within the spirit and scope of the appended claims, and equivalents thereof. Therefore, the aforementioned embodiments should be understood to be examples that do not necessarily limit the present disclosure in any way.

What is claimed is:

1. A negative active material for a rechargeable lithium battery, comprising;
a silicon-carbon composite; and
graphene on a surface of the silicon-carbon composite,
wherein a specific surface area of the negative active material is about 1.6 m²/g to about 2 m²/g.

2. The negative active material for a rechargeable lithium battery as claimed in claim 1, wherein the negative active material has an electrical conductivity of about 16 S/cm or more.

3. The negative active material for a rechargeable lithium battery as claimed in claim 2, wherein the negative active material has an electrical conductivity of about 16 S/cm to 40 S/cm.

4. The negative active material for a rechargeable lithium battery as claimed in claim 1, wherein the specific surface area of the negative active material is up to 30% higher than that of the silicon-carbon composite alone.

5. The negative active material for a rechargeable lithium battery as claimed in claim 4, wherein the negative active material has a specific surface area of more than about 100% to 130% or less based on 100% of a specific surface area of the silicon-carbon composite alone.

6. The negative active material for a rechargeable lithium battery as claimed in claim 5, wherein the negative active material has a specific surface area of about 110% to 130% or less based on 100% of a specific surface area of the silicon-carbon composite.

7. The negative active material for a rechargeable lithium battery as claimed in claim 1, wherein an amount of the graphene is about 0.6 parts by weight to about 4 parts by weight based on 100 parts by weight of the negative active material.

8. The negative active material for a rechargeable lithium battery as claimed in claim 1, wherein the silicon-carbon composite has a porous structure.

9. The negative active material for a rechargeable lithium battery as claimed in claim 1, wherein the silicon-carbon composite comprises nano silicon and amorphous carbon.

10. The negative active material for a rechargeable lithium battery as claimed in claim 9, wherein a mixing ratio of the nano silicon and the amorphous carbon is a weight ratio of about 70:30 to about 40:60.

11. A rechargeable lithium battery, comprising:
a negative electrode comprising the negative active material as claimed in claim 1;
a positive electrode comprising a positive active material; and
a non-aqueous electrolyte.

12. The rechargeable lithium battery as claimed in claim 11, wherein the negative electrode comprises the negative active material as a first negative active material and further comprises a crystalline carbon as a second negative active material.
